(19) United States
(12) Patent Application Publication
(10) Pub. No.: US 2008/0215725 A1
(43) Pub. Date: Sep. 4, 2008

(54) SYSTEMS AND METHODS FOR MANAGING THE PLAYING OF RING TONES AND OTHER MEDIA FILES ON MOBILE DEVICES

(75) Inventors: Simon Anthony Backer, Vancouver (CA); Karl Anthony Reardon, North Vancouver (CA)

Correspondence Address: KNOBBE MARTENS OLSON & BEAR LLP, 2040 MAIN STREET, FOURTEENTH FLOOR, IRVINE, CA, 92614, US

(73) Assignee: Wireless Image Limited, Vancouver (CA)

(21) Appl. No.: 12/040,824

(22) Filed: Feb. 29, 2008

Related U.S. Application Data
(60) Provisional application No. 60/892,779, filed on Mar. 2, 2007.

(51) Int. Cl. G06F 15/173; G06Q 30/00

(52) U.S. Cl. 709/224; 705/1; 705/10

(57) ABSTRACT

Systems, methods, and software applications for managing the playing of ring tones and other media files on mobile devices are provided. In one embodiment, a software application executed by a processor of a mobile device tracks the playing of a media file on the mobile device and reports information regarding the playing of the media file from the mobile device to a server over a wireless network. In another embodiment, the media file is provided on the mobile device as a ring tone file.

### CROSS-REFERENCE TO RELATED APPLICATION

This application claims the benefit of U.S. Provisional Application No. 60/892,779, filed on Mar. 2, 2007, entitled SYSTEM AND PROCESSES FOR MANAGING THE PLAYING OF RING TONES AND OTHER MEDIA FILES ON MOBILE DEVICES, the disclosure of which is expressly incorporated herein by reference.

### BACKGROUND

A variety of features are offered by mobile communication devices to enhance an end user's experience. One such feature is the ability for end users to select and use one or more ring tones for indicating incoming calls. The popularity of using such ring tones has increased rapidly over recent years. Accordingly, ring tone providers have increased the selection and type of media files available for use as ring tones.

With the proliferation of the market for ring tones, a need exists for offering enhanced ring tone services and for systems and methods for managing the playing of ring tones on mobile devices.

### SUMMARY

Systems, methods, and software applications for managing the playing of ring tones and other media files on mobile devices are provided.

In one embodiment, a media file management (MFM) system is provided that comprises a mobile client application having the ability to remotely track media file play events on mobile/wireless devices (e.g., mobile phones and PDAs), and a server system configured to collect and analyze media file usage and to compensate the users of such devices for such play events. The media files are preferably ring tone media files, and the ring tone media files preferably contain audio advertising content associated with particular advertisers.

In some embodiments, video files containing both video and audio content may alternatively be used, particularly where the mobile devices are capable of displaying video content. In other embodiments, image files containing one or more static images, such as fixed graphics or photos, may alternatively be used. Thus, where this disclosure refers to an “audio file” or “ring tone,” it should be understood that a video file or image file may alternatively be used. Accordingly, a media file as referred to herein includes any combination of one or more of the following files: audio or ring tone files, video files, and image files.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrative of one embodiment of a media file management system including a media file management component and one or more mobile communication devices;

FIG. 2 is a block diagram illustrative of aspects of the media file management component depicted in FIG. 1;

FIG. 3 is a block diagram illustrative of aspects of the one or more mobile communication devices depicted in FIG. 1;

FIGS. 4A and 4B are simplified block diagrams of the media file management system of FIG. 1 illustrating the registration of both a third party component and a mobile communication device with the media file management component and the tracking, analysis, and management of information regarding the playing of at least one media file on the mobile communication device;

FIG. 5 is a flow diagram of an illustrative method for tracking and reporting information associated with the playing of one or more media files on a mobile communication device; and

FIG. 6 is a flow diagram of an illustrative method for managing information regarding media files and determining compensation for end users based on information associated with playing one or more media files.

### DETAILED DESCRIPTION

A system will now be described that embodies various inventive features related to the management of playing media files on a mobile communication device, such as a mobile phone. As will be recognized, many of these features can be used independently of others, and represent distinct inventions. Further, many of the features can be implemented differently than described herein. Thus, nothing in this detailed description implies that any particular feature, component, process step, characteristic, of combination of the foregoing is essential.

Generally described, representative embodiments disclosed herein correspond to systems, methods and software applications for the management of playing media files, e.g., ring tone files, on a mobile communication device. Specifically, aspects of select embodiments relate to tracking the playing of a media file on a mobile communication device and reporting information regarding the playing of the media file. Further aspects in other embodiments relate to compensating end users based, at least in part, on the reported information.

A media file management (MFM) system in accordance with one embodiment of the present disclosure allows advertisers and other third parties interested in the usage of audio files on wireless devices to distribute audio files to mobile devices of consumers (“end users”). The system monitors the audio file usage on such devices, and reports resulting audio file usage data back to the advertisers, audio file distributors or other third parties in a variety of forms and reports. The tracked usage data may also be used to compensate end users, as described below.

A media file management (MFM) component of the MFM system, as further described below, is preferably operated by a business entity, referred to herein as the MFM service provider. The MFM service provider is typically separate from, but may operate in partnership with, the wireless carrier(s) associated with the mobile phones. However, in some embodiments, the media file management (MFM) component could be implemented and operated by a particular wireless carrier to better service its customers.

From a business model perspective, advertisers, distributors, or other third parties buy a service from the MFM service provider (i.e., the provider/operator of the MFM component of the MFM system). This service includes some or all of the following (in all possible combinations):
The hosting of audio files on one or more servers of the MFM system.
The downloading/transfer of such audio files over a wireless carrier's network to the mobile phones of end users, either via a pull model in which consumers select specific audio files to download, or via a push/targeting model in which the MFM component selects the audio files based on attributes of the corresponding end users.
Audio file usage reports and tracking.
Transfer of monetary or other compensation from advertisers to the end users.
The collection and storage of end user profile data, and the use of such data to select audio files to deliver to and play on particular end user's mobile devices. The user profile data may, for example, include one or more of the following: (a) preferences and demographic data explicitly supplied by the end users through a web site of the MFM service provider; (b) user preferences inferred from monitoring the web browsing and/or calling activities of the end users; (c) demographic and other data obtained through partnerships with other entities, such as credit bureaus, social networking sites, and e-commerce sites.

The MFM system permits the managed delivery, download, usage, and tracking of audio files or ring tones on mobile phones, smartphones, PDAs and other wired or wireless communications devices. The ring tones may include songs, branded audio or audio advertising content, MP3 clips, or other digital audio or video encoded clips, or other audio files used to alert wireless device users of an incoming call or other event such as proximity to an advertiser's commercial outlet.

The MFM system supports a unique business model which allows end users to conveniently select which audio file they wish to play on their devices. The MFM system incorporates proprietary software loaded onto phones that monitors the audio files played, as well as their volume setting in other embodiments. This software captures the usage information, including play event time-stamps, into a table and periodically sends this information to a tracking server where it is consolidated. Other parameters may also be captured including current geographic location, length of call, who is calling etc. It will be appreciated by those skilled in the art and others that the information captured can include data related in any way to the particular play event being monitored, whether obtained immediately preceding, simultaneous with, or subsequent to the occurrence of the specific play event.

End users may receive compensation in the form of cash credits or coupons/discounts based partially or wholly on the number of plays (e.g. calls received or other plays of the audio files). Audio file producers and/or advertisers receive reports which provide details on the usage of particular audio files. These reports may then be used to gauge popularity, effectiveness, etc. as well as to manage end user credits or other benefits. The reports may, in some embodiments, include anonymous information, such as demographic data, about the users who selected particular audio files. For example, a given report may display, for each audio file, a break down of the play events by geographic region, time of day, end user income level, or any other end user attribute of classification.

Within the value chain, there are four major types of participants:
The Advertiser/Sponsor
The End User
The Wireless Carrier
MFM Service Provider

The Advertiser/Sponsor is the primary customer for the service offered by the MFM Service Provider. Advertisers/sponsors may buy a service and/or campaign which will enable them to offer audio files or branded ring tones via the service provided by the MFM Service Provider.

The advertisers/sponsors may use a variety of means to make the availability of their audio files known to potential end users. For example, advertisers may post such files to a web site operated by the MFM Service Provider together with associated keywords and descriptions, possibly including descriptions of associated incentives; end users may then browse this web site, and use these keywords or descriptions to select particular audio files to download. Alternatively, the audio files may be pushed to the end user's mobile communication devices such that the end users need not select particular audio files to download.

The advertisers/sponsors may pay for all or part of the:
Basic hosting of the audio file
Download of the audio file to the wireless device (i.e. the wireless data service associated with the download)
Compensation to end user for each validated play of the audio file
Reports from the MFM Service Provider on the number of plays, downloads, etc.
Any combination of above
   The above services may be sold either directly to producers/advertisers or indirectly through advertising agencies or other third parties.

In some embodiments, the End Users actively download the audio files from one or more servers of the MFM component or via a redirect from the advertiser's or third party server. The end users may enter into an agreement in which they agree to place the audio file onto their mobile communication devices and have plays, and associated parameters, of that audio file monitored by the MFM component. In exchange, the end user may receive whatever compensation is being offered by the advertiser, including discounts, coupons, loyalty program points, special promotions, wireless service rebates or any other incentives. Compensation may be based upon the end user achieving and/or maintaining specified usage levels as specified by the advertiser/sponsor.

The Wireless Carrier provides the wireless data services to support the offering. The MFM service provider may enter into relationships with a number of carriers, and may pay for the air time or bandwidth used to implement the service. The wireless carriers may promote the MFM system since doing so may increase wireless data revenue.

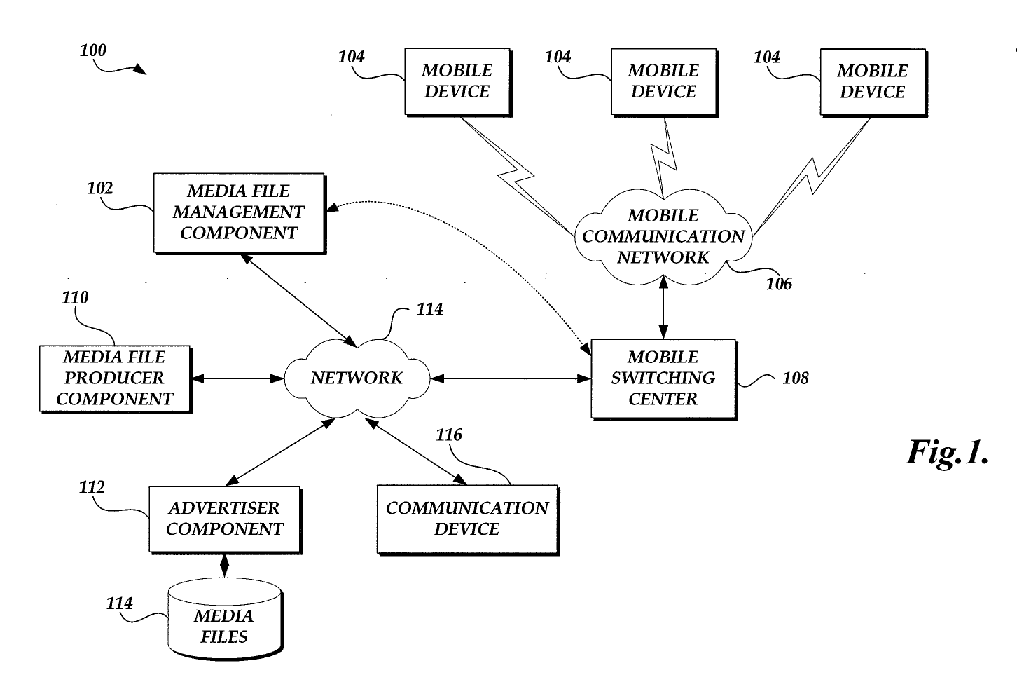

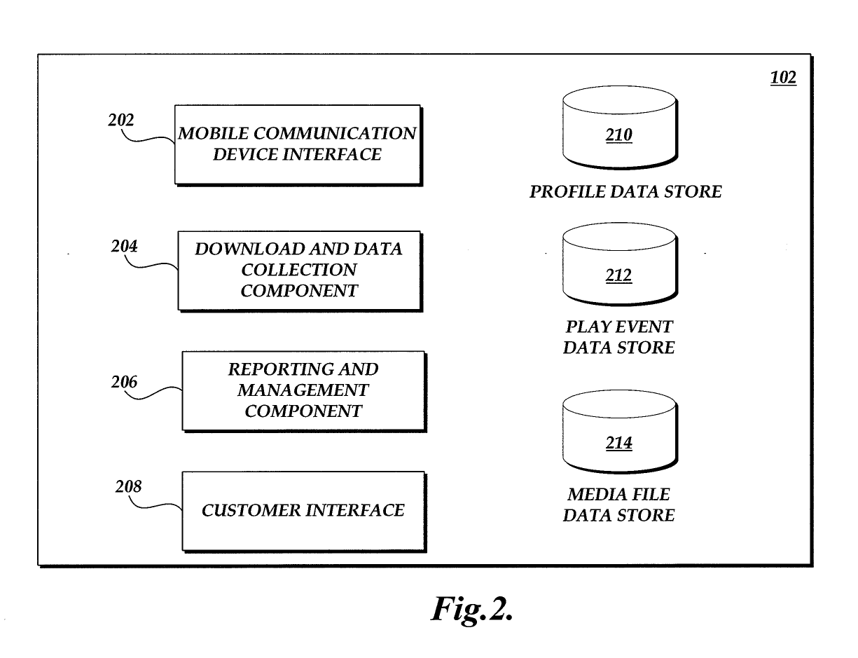

With reference now to FIG. 1, a block diagram illustrative of a media file management (MFM) system 100 for managing the play of at least one media file on one or more mobile communication devices will be described. As illustrated in FIG. 1, the MFM system 100 includes a media file management (MFM) component 102 for managing and reporting information regarding play events occurring on the one or more mobile communication devices. In an illustrative embodiment, the MFM component 102 manages the registration of a third party, such as an advertiser, desirous of providing media file content to end users and compensating end users for playing the media file content, as well as the registration of mobile communication devices of end users. Illustrative components of the MFM component 102 will be described in greater detail with regard to FIG. 2.

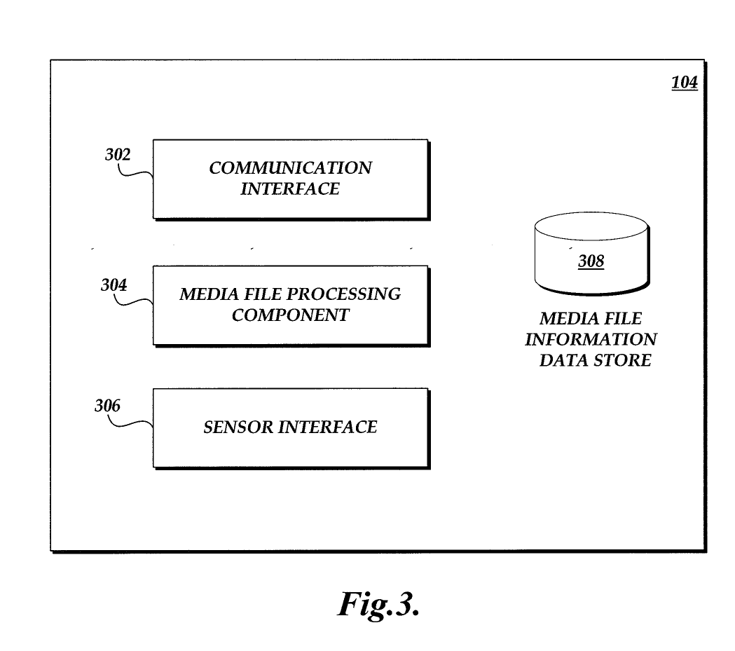

With continued reference to FIG. 1, the MFM system 100 includes one or more mobile communication devices 104. The mobile communication devices 104 can correspond to wide variety of devices or components that are capable of initiating, receiving or facilitating communications over a communication network including, but not limited to personal computing devices, hand-held computing devices, integrated components for inclusion in computing devices, home electronics, appliances, vehicles, and/or machinery, mobile telephones, modems, personal digital assistants, laptop computers, gaming devices, and the like. In an illustrative embodiment, the mobile communication devices 104 include a wide variety of software and hardware components for establishing communications over one or more communication networks, including wireless or wired mobile communication networks 106 and 114, respectively. Illustrative components of a mobile communication device 104 will be described in greater detail with regard to FIG. 3.

With continuing reference to FIG. 1, an illustrative MFM system 100 can include a number of additional components, systems and/or subsystems for facilitating communications with the mobile communication devices 104 and/or the MFM component 102. The additional components can include one or more mobile switching centers 108 for establishing communications with the mobile communication devices 104 via the mobile communication network 106, including any network configured to establish one or more communication channels corresponding to various communication protocols such as Bluetooth, the family of IEEE 802.11 technical standards (“WiFi”), the IEEE 802.16 standards (“WiMax), short message service (“SMS”), voice over IP (“VoIP”) as well as various generation cellular air interface protocols (including but not limited to air interface protocols based on CDMA, TDMA, GSM, WCDMA, CDMA2000, TD-SCDMA, WTDMA, OFDMA and similar technologies). The operation of mobile communication networks, such as mobile communication network 106, are well known and will not be described in greater detail.

As illustrated in FIG. 1, the mobile switch center 108 includes interfaces for establishing various communications via the communication network 114, such as the Internet, intranets, private networks and point-to-point networks. In one example, the mobile switch center 108 can include interfaces for establishing communication channels with various communication devices 116, such as landline telephones or VoIP communication devices, via a wired network. Still further, the mobile switch center 108 can include interfaces for establishing communication channels with a mobile-based communication device, such as another mobile communication device. It will also be appreciated by those skilled in the art and others that although communication network 114 is illustrated as a single communication network, the communication network 114 can be made up of any number of public or private communication networks and/or network connections.

One skilled in the relevant art will appreciate that the components and configurations provided in FIG. 1 are illustrative in nature. Accordingly, additional or alternative components and/or configurations, especially regarding the additional components, systems and subsystems for facilitating communications may be utilized.

With reference now to FIG. 2, illustrative components for the MFM component 102 will be described. Although the operation of the various functions associated with the MFM component 102 will be described with regard to below subcomponents, one skilled in the relevant art will appreciate that the subcomponents are illustrative in nature. Accordingly, a MFM component 102 may include additional components or alternative components to facilitate one or more functions. Additionally, although the various subcomponents are illustrated as integrated into a MFM component 102, one or more of the components may be implemented in a distributed matter over a communication network and/or be implemented as a network service, e.g., a Web service.

As illustrated in FIG. 2, the MFM component 102 includes a mobile communication device interface 202 for establishing communications with a mobile communication device 104. In an illustrative embodiment, the mobile communication device interface 202 corresponds to a bi-lateral interface for facilitating the transfer of data between the mobile communication device 104 and the MFM component 102. The mobile communication device interface 202 can include software and hardware components necessary to establish one or more communication channels corresponding to various communication protocols such as Bluetooth, the family of IEEE 802.11 technical standards (“WiFi”), the IEEE 802.16 standards (“WiMax), short message service (“SMS”), voice over IP (“VoIP”) as well as various generation cellular air interface protocols (including but not limited to air interface protocols based on CDMA, TDMA, GSM, WCDMA, CDMA2000, TD-SCDMA, WTDMA, OFDMA and similar technologies).

The MFM component 102 can also include a download and data collection component 204 for downloading a mobile client application, as well as one or more media files, to a mobile communication device 104, and for collecting information regarding play events from a mobile communication device 104. In addition, the MFM component 102 can include a reporting and management component 206 for managing information regarding media file play events received from one or more mobile communication devices 104 and reporting such information to a third party, such as advertiser component 112.

In further illustrative embodiments, the download and data collection component 204 is preferably responsible for (e.g., programmed to perform) some or all of the following:
Managing the end user sign-up process including end user demographic data.
Presentation of the appropriate client application to end users through wml, web pages or through other file download technologies.
Managing the client application download process to the end user.
Presentation of available media files to the client applications, wml and html browsers.
Managing the media file download process to client application, wml and html browsers.
Reporting information related to the download of client applications and media files for each registered user to the reporting and management component 206.
Receiving, authenticating and decrypting media file event data from client applications and forwarding to the reporting and management component 206.
Providing client application and media file updates periodically or on command.
Requesting client application event tables on command.
Deregistering and inactivating client applications on command.
Downloading of loyalty points, coupons, service credits, or other incentives to end users or wireless carriers or other third parties.

In embodiments in which the MFM component 102 automatically selects audio files to deliver to/play on the mobile communication devices 104, the download and data collection component 204 may also be programmed to perform one or more of the following:
Storing, in association with particular media files, advertiser-supplied user attributes specifying the types of end users to which such files are to be targeted.
Maintaining user profiles for particular end users. These profiles may be based on one or more of the sources of information specified above.
Matching media files to end users/mobile communication devices 104 based on automated comparisons of the advertiser-supplied user attributes to the stored user profiles.

In some cases, advertisers may also be permitted to offer particular incentives to particular classes of users (e.g., all users who reside in a particular geographic area). In such cases, the download and data collection component 204 may expose, to each given end user, the particular advertiser incentives/offers for which that user qualifies.

In another illustrative embodiment, the download and data collection component 204 can be configured to receive media file play event data from mobile communication devices as a part of a communication protocol. For example, the event data may be transmitted as part of a handshaking protocol that the mobile communication device 104 would use for establishing or terminating a mobile communication call. Alternatively, the download and data collection component 204 can be configured to receive media file play event data through a dedicated data connection.

The reporting and management component 206 is responsible for (e.g., programmed to perform) at least some, and preferably all, of the following:
Receipt of end user sign-up, media file download, usage, and deregistration statistics form the download and data collection component 204.
Determination of fraudulent or abnormal behavior on the behalf of end users and limiting, restricting, or terminating registration of those accounts.
Supply of reports to media file producers, such as media file producer component 110, related to the number of sign-ups, attributes associated with media file usage including:
   Usage frequency in aggregate and during selected time or date periods.
   Media file usage by location.
   Usage by end user demographic.
   Duration of use prior to replacement by another media file.
   Raw event and usage information for the generation of custom reports.
   Some combination of the above.
Supply of billing information to media file producer component 110 and/or advertiser component 112.
Supply of loyalty points, coupons, service credits, or other incentives to end users or wireless carriers or other third parties. This may be accomplished by a variety of methods, including, for example, one or more of the following methods: (1) sending credit messages to the end user's wireless carrier, causing the wireless carrier to apply monetary credits to the end user's bill/account; (2) sending coupons or coupon codes directly to the end user via email or other communication method; or (3) where the end user's mobile device includes electronic wallet functionality, sending a message that causes a monetary amount or other credit to be added to the end user's wallet.
Managing end user registration and state.

Still further, the MFM component 102 can include a customer interface 208 for facilitating communication with advertiser component 112 and/or media file producer component 1 10.

The MFM component 102 can further include a mobile communication device profile data store 210 for maintaining mobile communication device profiles, a play event data store 212 for maintaining play event data collected from mobile communication devices 104 and for maintaining reports for providing to advertiser component 112 and/or media file producer component 110. The MFM component can yet further include a media file data store 214 for maintaining media files provided by advertiser component 112 and/or media file producer component 110. While illustrated as separate data stores 210, 212, 214, it will be appreciated by those skilled in the art and others that one or more data stores may be provided to store the data and/or the software applications utilized by the MFM component 102 in performing any one or more of the above described functions. Additionally, one or more of the data stores may be remotely located or otherwise distributed.

With reference now to FIG. 3, illustrative components for the mobile communication device 104 will be described. Although the operation of the various functions associated with the mobile communication device 104 will be described with regard to below subcomponents, one skilled in the relevant art will appreciate that the subcomponents are illustrative in nature. Accordingly, the mobile communication device 104 may include additional components or alternative components to facilitate one or more functions. Additionally, although the various subcomponents are illustrated as integrated into a mobile communication device 104, one or more of the components may be implemented in a distributed matter over a communication network and/or be implemented as a network service, e.g., a Web service.

As illustrated in FIG. 3, the mobile communication device 104 includes a communication interface 302 for facilitating communications with the MFM component 102. As described above with regard to the mobile communication device interface 202 (FIG. 2), the communication interface 302 facilitates the bi-lateral transfer of data between the mobile communication device 104 and the MFM component 102. The communication interface 302 can include software and hardware components necessary to establish one or more communication channels corresponding to various communication protocols. Moreover, although the communication interface 302 is illustrated as a separate component, the functionality of the component may be integrated, or otherwise combined, with one or more hardware or software components utilized by the mobile communication device 104 to make communication links (e.g., cellular communication links or SMS communication links as part of the designed function of the mobile device). As similarly described above and set forth further below, the communication interface 302 can be configured to transmit media file play event data to the MFM component 102 as part of a handshaking protocol that the mobile communication device 104 would use for establishing or terminating a mobile communication call. Alternatively, the communication interface 302 can be configured to send media file play event data through a dedicated data connection.

The mobile communication device 104 can also include a media file processing component 304 for executing the mobile client application downloaded from the MFM component 102. Illustrative algorithms or processes of the mobile client application will be described in greater detail below. In one illustrative embodiment, the mobile client application causes the media file processing component 304 to track information associated with the playing of one or more media files on the mobile communication device 104 and report such information to the MFM component 102.

In further illustrative embodiments, the mobile client application works in conjunction with the components of the MFM component 102 to manage the download of media files and to track and report the usage of media files, e.g., ring tones, played on the wireless device. The information captured on the mobile devices is periodically reported by the mobile client application to the MFM component, where it is aggregated with similar information from other end users. The collected/aggregated usage information may be used by the MFM component 102 to:
Prepare usage reports that are transmitted to advertiser component 112 and/or media file producer component 110.
Calculate credits due to particular end users.

The mobile client application, which is intended to run on a wide range of mobile communication devices, is responsible for at least some, and preferably all, of the following:
Presenting available media files (or metadata associated with such files) to the end user from the download and data collection component 204.
Managing the media file download and installation process from the download and data collection component 204.
Facilitating the user selection of media files for each event or notification type (calls, alarms, messages, etc.) based on media files currently available on the wireless devices.
Managing the playing of selected media files based on time of day, location, event type, calling party, advertiser-supplied play criteria and/or some combination of the preceding.
Removing or restricting access to media files based on any number of attributes of the audio file including, for example, number of plays, age, lifespan, expiry date, and/or location.
Capturing the events corresponding to the playing of media files including time, date, volume setting, location, etc.
Compressing and/or encrypting event data.
Securely and efficiently uploading event data to the MFM component 102 based on a number of parameters including elapsed time, time of day, event table size, or on request from the MFM component.
Managing the transmission of event tables using SMS, WiFi, WiMAX, Cellular Data (e.g. GPRS, EDGE, HSDPA, 1xRTT, EV-DO, etc.) or other wireless protocols.
Managing application removal and a service de-registration process in the event that the end user wishes to unsubscribe.
Ensuring that certain parameters of the business terms and conditions are met to prevent abuse of the service e.g. spoofing of the system to receive an abundance of incoming calls.

While the primary intent is to manage and report on the usage of selected media files, the mobile client application is not restricted to solely managing these files and can also manage media files and downloads from other sources and optionally include the use of these media files in the event reports.

The media file downloaded may in fact consist of a series of files that are intended to be played at different times of days. The mobile client application may automatically manage the playing of the correct media file in the correct time windows. In this way an advertiser is able to provide time-sensitive messaging to end users.

In some cases, specific media files may be associated with geographic location tags/indicators indicating the geographic locations in which they should be played. In such cases, the mobile client application may use GPS-based or other location data to select the appropriate media file to play.

The mobile client application is designed in a manner which permits it to be downloaded over a wireless network or be installed at the time of the device manufacture or configuration. The mobile client application can optionally be bundled with one of more media files in a self-extracting and installing format to permit the easy and convenient introduction of the service.

In one embodiment, the end user initiates the client-application download process, such as by inputting the Internet address of a particular server. Alternatively, the process could be initiated by the end user sending a text message to a pre-determined address. Prior to the mobile client application being downloaded, the end user may be presented with a message stating, for example, that “the software client being downloaded is to be used in accordance with the Terms and Conditions available at www.wireless-image.com. Do you agree? Yes/No”

If the end user selects ‘Yes’, the download process will proceed. If the end user selects No, the process will terminate and the phone will return to its former state.

Once the mobile client application is downloaded into the wireless device, it will automatically install and launch itself along with any associated audio files. Minimal end user action is required.

The mobile client application preferably runs in the background with no indications to the end user.

In one embodiment, once installed on the wireless device, the mobile client application preferably detects at least the following information whenever an incoming call is received, or whenever another event occurs which causes a media file to be played:
Media file played
Volume setting
Time/Date
Location

The mobile client application may capture this information in a minimal amount of time. For example, the mobile client application might read and store the current ring tone value and update this value each time the ring tone is changed. When an incoming call is received the mobile client application will then be able to easily deduce the ring tone that was played.

Similarly, changes to the volume setting for the ring tone may be monitored.

Lastly, when an incoming call is received the mobile client application will capture the date and time (YYYY, HH:MM:SS).

Each time an incoming call is received, the mobile client application preferably captures the information described in the previous section.

The mobile client application writes these values into a table in an expedient and secure manner. The exact method and timing by which this is achieved may depend on the operating system on the mobile communication device.

The table, which may be stored in the non-volatile memory of the mobile communication device (together with the executable code of the mobile client application), may have a structure similar to Table 1 below:

TABLE 1

| Call | Ringtone | | | |
|---|---|---|---|---|
| sequence # | Value | Volume Setting | Location | Date/Time |
| #### | #### | ## | ######### | ####; |
| | | | | HH:MM:SS |

As more calls are received, the table described in Table 1 will fill up. Periodically the table may be ‘packed’ into text messages that are sent back to the MFM component 102. This may be accomplished by, e.g., compressing the table data into the payload of a standard text message (e.g., 140, 8-bit bytes) or another format which is efficient based on the wireless networks available to the wireless device.

In addition to being compressed, the data from Table 1 may be encrypted to inhibit:
Fraudulent messages being created and being targeted to the MFM component 102.
Privacy concerns for end users through the interception of these messages.

The level of encryption used may be quite lightweight as compared to say a banking transaction. It may be sufficient to use a simple hashing scheme employing sequence numbers and some unique value associated with the mobile communication device (e.g. mobile phone #, EMEI etc.).

The mobile client application sends the event table messages described above to the MFM component 102 of the MFM system for further processing. In various embodiments, the timing of the sending of the messages may be based on one or more of the following:
Each time the data collected fully populates the pay-load of the wireless network service available.
Each time a periodic timer elapses. Nominally this will be set to 30 days (to match the end user's billing cycle.
At a specific time or date.
Some combination of the above criteria.

The end user may be able to easily uninstall the mobile client application.

Upon initiating the uninstall process, the end user shall be presented with a message similar to the following: “You are about to uninstall the Wireless Image client. This will terminate your agreement with Wireless Image and mean that you are no longer eligible to receive any further benefits per the Terms and Conditions available at www.wireless-image.com. Do you wish to proceed with uninstalling the mobile client application? Yes/No.”

If the end user selects Yes, the mobile client application will be uninstalled and a text message will be sent to the MFM component 102 indicating the mobile phone number, the time/date, mobile client application uninstalled status.

If the end user selects No, the mobile communication device 104 will return to its former state.

With continued reference to FIG. 3, the mobile communication device 104 can also include a sensor interface 306 for obtaining inputs corresponding to a mobile communication device environment. In an illustrative embodiment, the set of inputs can include information from one or more sensors such as a global position sensor (GPS) component or other location identification components.

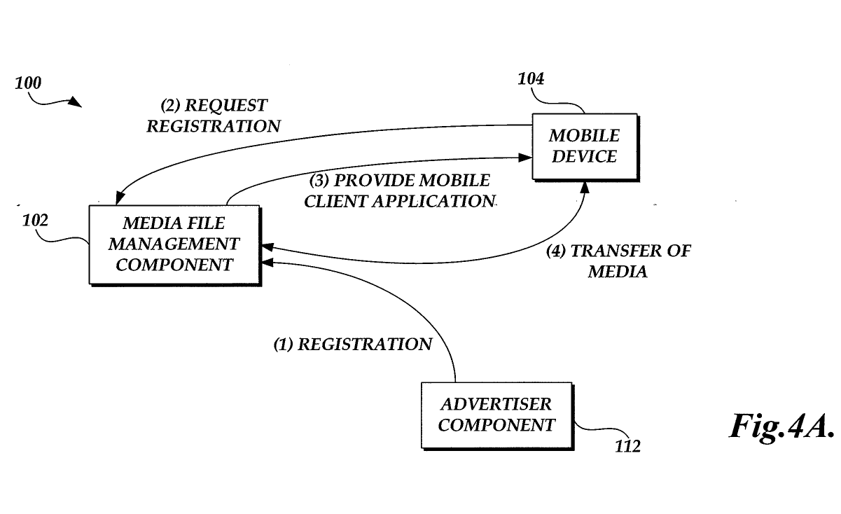

With reference now to FIGS. 4A and 4B, the interaction between various components of the MFM system 100 of FIG. 1 will be illustrated. For purposes of the example, however, the illustration has been simplified such that many of the systems, subsystems, and components utilized to facilitate communications are not shown. One skilled in the relevant art will appreciate that such components or subcomponents can be utilized and that additional interactions would accordingly occur without departing from the spirit and scope of the present invention.

With reference now to FIG. 4A, in an illustrative embodiment, a third party component, such as the advertiser component 112, registers with the MFM component 102 in order to provide one or media files to an end user of a mobile communication device 104. As part of the registration process, the advertiser component 112 provides the criteria associated with the play of one or more media files which can result in a particular compensation for the end user. For example, a brand advertiser may create an audio ring tone to promote their product or service, download this ring tone to the MFM component 102, and designate that a certain number of ring tone plays would result in providing the end user of the mobile communication device 104 with a discount coupon for the brand advertiser's product or services.

In further reference to FIG. 4A, once an end user of a mobile communication device 104 requests to register with the MFM component 102, the mobile client application is downloaded from the MFM component 102 and installed on the mobile communication device 104. A select media file, in this example the brand advertiser's audio ring tone file, is also provided from the MFM component 102 to the mobile communication device 104. While the media file can be provided by the MFM component 102 upon request or pushed to the mobile communication device 104 of the end user, in this illustrative embodiment, the end user separately reviews available ring tones and chooses to download and install the brand advertiser's ring tone on the mobile communication device 104.

Turning to FIG. 4B, continuing with the present illustrative embodiment, the mobile communication device 104 tracks the playing of the downloaded audio ring tone file on the mobile communication device 104. Next, the mobile communication device 104 provides information associated with the playing of this audio ring tone file, e.g., the number of times the audio ring tone file has been played, to the MFM component 102. The media management component 102 in turn determines compensation for the end user based, at least in part, on the reported information regarding the playing of the audio ring tone file. For example, the media management component 102 determines whether the number of times the audio ring tone file was played meets or exceeds the advertiser component's criteria for being compensated. The media management component 102 reports this information to the advertiser component 112. If the criteria has been met, the MFM component 102 also provides the designated compensation to the end user of the mobile communication device 104. It will be appreciated by those skilled in the art and others that the MFM component 102 may first require that the designated compensation award be received from the advertiser component 112 before resolving compensation with the end user. However, the MFM component 102 may also resolve compensation with the end user before being provided such compensation from the advertiser component 112, and even further, before reporting such information to the advertiser component 112.

The following paragraphs provide other possible illustrative use cases.

In a further illustrative embodiment, a film producer creates an audio ring tone and video file to promote their film an enter into a business agreement with the MFM component 102 to place the ring tone on the MFM component 102. End users can review available ring tones and video files and would download and install the film producer's ring tone and video file on their mobile communication device 104. Every phone call and alert which causes this ring tone to be played is monitored and reported to the MFM component 102. Upon download the end user is provided with a discount for a movie ticket purchase as an initial reward for downloading the media file and is also entered into promotional contests based on reaching specified thresholds of ring tone plays.

In another illustrative embodiment, a music producer creates an audio ring tone to promote their new music production and enters into a business agreement with the MFM component (or practically with provider of this service) to place the ring tone on the MFM component. End users can review available music ring tones and would download and install the music producer's ring tone on their mobile communication device 104. Every phone call and alert which causes this ring tone to be played is monitored and reported to the MFM component 102. Upon reaching a specified threshold in terms of number of ring tone plays or for sharing or referring the music ring tone with/to other end users, the end user is provided with a free song download. The number of music ring tone plays is reported to the music producer to permit them to gauge the popularity of the release.

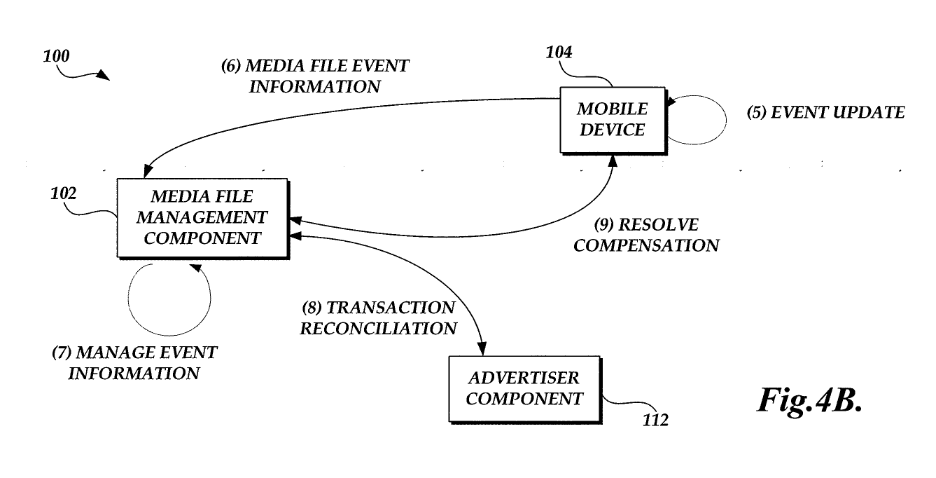

With reference now to FIG. 5, one embodiment of a routine 500 for tracking and reporting information associated with the playing of one or more media files on a mobile communication device 104 will be described. At block 502, the routine 500 begins with tracking the play of at least one media file on the mobile communication device 104. At block 504, the mobile communication device 104 reports information regarding the playing of the at least one media file to the MFM component 102. In other embodiments, it will be appreciated that routine 500 tracks play events specifically resulting from incoming telephone calls to the mobile communication device 104 and reports associated play event data to the MFM component 102. In addition, other specific play events may be monitored such as those resulting from playing ring back tones to incoming callers or from playing ring tones for other types of alert messages played on the mobile communication device, such as event notifications for an SMS message receipt, instant messaging receipt, calendar appointment, alarm, etc. In yet further embodiments, at block 506, the routine 500 may optionally receive resolved compensation information for the end user from the MFM component 102 after the MFM component 102 determines that compensation is due the end user. The routine ends at block 508.

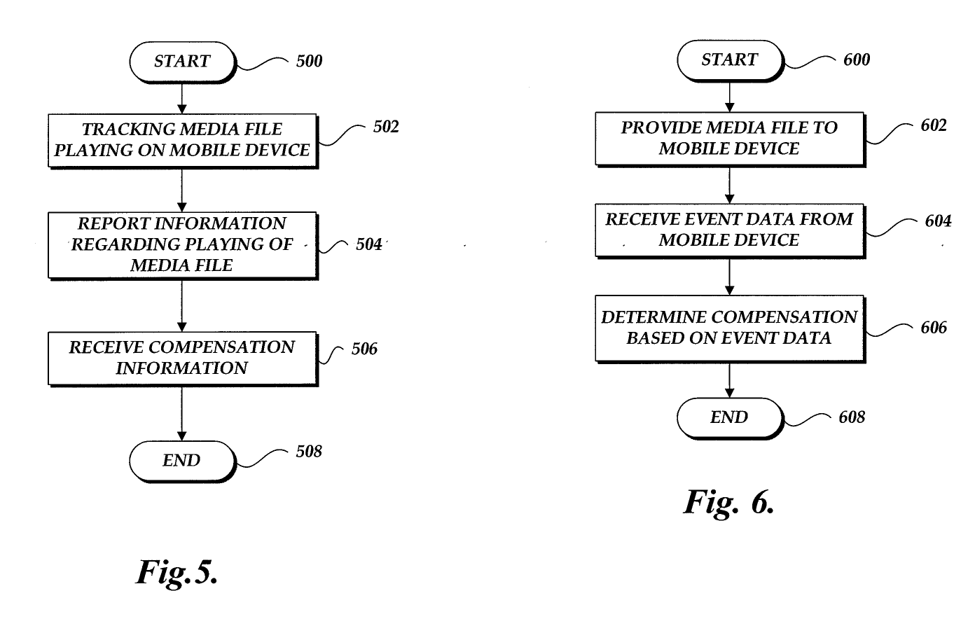

With reference now to FIG. 6, one embodiment of a routine 600 for managing information regarding media files and determining compensation for end users based on information associated with playing one or more media files will be described. At block 602, the routine 600 begins with providing a media file over a wireless communication network to a mobile communication device 104 of an end user. Information associated with the playing of the media file on the mobile communication device 104 is received by the media management component 102 from the mobile communication device 104 at block 604. Next, at block 606, compensation for the end user is determined based, at least in part, on the received information associated with the playing of the media file. The routine ends at block 608.

In another embodiment, routine 600 may further include receiving, at the media management component 102 from a third party, associated target user criteria together with the media file. In this embodiment, the step of providing the media file further includes programmatically matching the media file to an end user based on the target user criteria and a profile of the end user and thereafter providing the matched file to the mobile communication device 104 of the end user.

It will be appreciated by those skilled in the art and others that all of the functions described in this disclosure may be embodied in software executed by one or more processors of the disclosed components and mobile communication devices. The software may be persistently stored in any type of non-volatile storage.

In yet other embodiments, it will be appreciated by those skilled in the art and others that the MFM component 102 can be configured to track and manage the playing of a media file in accordance with any of the above described embodiments on any communication device, including wired devices such as communication device 116. In such embodiments, the software functions described above as being applicable to the mobile client application can be similarly implemented as a client application for such communication devices.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A computerized method, comprising:
tracking the playing of at least one media file on a mobile device of an end user, wherein the tracking is performed via software executed by a processor of the mobile device; and
reporting information regarding the playing of the at least one media file from the mobile device to a server over a wireless network.

2. The method of claim 1, wherein the media file is an audio file.

3. The method of claim 2, wherein the audio file is provided on the mobile device as a ring tone file.

4. The method of claim 3 further comprises tracking play events resulting from incoming telephone calls to the mobile device.

5. The method of claim 4, wherein the audio file comprises promotional content supplied by an advertiser.

6. The method of claim 1, wherein the method comprises tracking and reporting geographic locations of the mobile device.

7. The method of claim 1, wherein the media file is a multimedia file containing both audio and video content.

8. A mobile client application which embodies the method of claim 1, stored in computer storage.

9. The method of claim 1, wherein the information is reported from the mobile device as part of the protocol for establishing or terminating a mobile communication call.

10. The method of claim 1, wherein tracking the playing of at least one media file comprises tracking a multiple number of times at least one media file is played.

11. A media file management system, comprising:
a mobile client application which runs on a mobile device of an end user, said mobile client application configured to track media file play events on the mobile device, and to report information about the play events over a wireless network; and
a server system which receives and stores the reported information regarding the media file play events, and generates reports that incorporate said information.

12. The system of claim 11, wherein the mobile client application tracks media file play events caused by incoming calls to the mobile device.

13. The system of claim 11, wherein the server system uses the information to determine an amount of compensation owed to an end user of the mobile device.

14. The system of claim 11, wherein the media file comprises advertiser-supplied content, and the server system is programmed to provide reports to the advertiser regarding the media file play events.

15. The system of claim 11, wherein the mobile client application is configured to report the information about the play events as a part of a transmission protocol used by the mobile device for establishing or terminating a mobile communication call.

16. The system of claim 11, wherein the media file play event is the playing of a ring tone file.

17. The system of claim 16, wherein the media file play event comprises playing the ring tone file as a result of an incoming call to the mobile device, playing the ring tone file as a ring back tone provided to incoming callers, or playing the ring tone file in response to an alert event on the mobile device.

18. A computerized method, comprising:
providing a media file over a wireless network to a mobile device of an end user;
receiving information from the mobile device associated with the playing of the media file on the mobile device; and
determining compensation for the end user based, at least in part, on the received information associated with the playing of the media file.

19. The method of claim 18, wherein the media file is provided on the media device as a ring tone file.

20. The method of claim 19, wherein the received information comprises identification of the number of times the ring tone file was played on the mobile device of the end user.

21. The method of claim 18 further comprises receiving, from a third party, the media file and associated target user criteria, wherein providing the media file comprises programmatically matching the media file to an end user based on the target user criteria and a profile of the end user and providing the matched media file.
